(19) United States
(12) Patent Application Publication
(10) Pub. No.: US 2025/0103858 A1
(43) Pub. Date: Mar. 27, 2025

(54) PASSING COMPLEX DATA OBJECTS IN LARGE LANGUAGE MODEL PROCESSES

(71) Applicant: Microsoft Technology Licensing, LLC, Redmond, WA (US)

(72) Inventors: Chi CHEN, Renton, WA (US); Alexander Solomon CHOCRON, Seattle, WA (US); Yousif Waleed ALMULLA, Bellevue, WA (US)

(73) Assignee: Microsoft Technology Licensing, LLC, Redmond, WA (US)

(21) Appl. No.: 18/475,933

(22) Filed: Sep. 27, 2023

(51) Int. Cl. G06N 3/0455; G06N 3/0475

(52) U.S. Cl. CPC G06N 3/0455; G06N 3/0475

(57) ABSTRACT

Examples are disclosed that relate to passing complex data objects as context variables between iterative prompts to AI models. One example provides a method, comprising receiving an input, constructing a prompt based upon the input, and inputting the prompt into an orchestrator. The method further comprises, based on the prompt, forming a context variable to reference complex data. The method further comprises providing modified input to a first AI plugin at a first orchestration stage, receiving the complex data from the first AI plugin, and storing the complex data as the context variable. The method further comprises modifying the prompt to include a reference to the context variable without modifying the prompt to include the complex data, thereby forming a modified prompt. The method further comprises providing the modified prompt to a generative model, receiving generated text from the generative model, and outputting the generated text with the complex data.

### BACKGROUND

Generative models, such as large language models (LLMs), have been developed that generate natural language responses in response to user inputs, such as natural language inputs. Recent LLMs have been based on transformer architectures that utilize tokenization and word embeddings to represent words in an input sequence, and a self-attention mechanism that is applied to allow each token to potentially attend to each other token in the input sequence during the training of the neural network. Examples of such LLMs include generative pre-trained transformers (GPTs) such as GPT-3, GPT-4, GPT-J, BLOOM, and LLAMA. Typically, these LLMs are sequence transduction transformer models that are trained on a next word prediction task. The models repeatedly make next word predictions to generate an output sequence for a given input sequence. Such models are trained on natural language corpora including billions of words and have parameter sizes in excess of one billion parameters. These parameters are weights in the trained neural network of the transformer. Some of these models are fine-tuned using reinforcement learning with human feedback or one-shot or few-shot learning based on ground truth examples.

As a result of their large parameter size and in some cases their fine tuning, such LLMs have achieved superior results in many tasks compared to other generative models. Such tasks may include generating responses to user inputs in a series of chat-style messages that substantively respond to an instruction in the prompt, in a particular writing style or format specified by the prompt, to a particular audience, and/or from a particular author's point of view.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to passing complex data objects as context variables between iterative prompts to AI plugins and/or generative models. One example provides a method enacted on a computing system. The method comprises receiving, at the computing system, an input from a client, constructing a prompt based upon the input, and inputting the prompt into an orchestrator. The method further comprises using the orchestrator to select one or more artificial intelligence (AI) plugins for processing the prompt at one or more corresponding orchestration stages selected by the orchestrator. The method further comprises, using the orchestrator, and based on the prompt, forming a context variable to reference complex data. The method further comprises providing modified input to a first AI plugin at a first orchestration stage, receiving the complex data from the first AI plugin, and storing the complex data as the context variable. The method further comprises modifying the prompt to include a reference to the context variable without modifying the prompt to include the complex data, thereby forming a modified prompt. The method further comprises providing the modified prompt to a generative model, receiving generated text from the generative model, the generated text comprising the reference to the context variable, and providing the generated text and the complex data to the client.

### BRIEF DESCRIPTION OF THE DRAWINGS

FIGS. 1A-1B show an example scenario in which a user submits a query to an artificial intelligence (AI) model on a remote computing system and receives complex data objects in return.

FIG. 2 schematically shows an example orchestrator configured to pass a context variable between AI plugins while storing but not passing complex data between the AI plugins.

FIG. 3 shows an example complex data object comprising chemical structure data.

FIG. 4 shows an example complex data object comprising citation data including a uniform resource locator (URL).

FIGS. 5A-5B show a flow diagram for an example method of processing a user input by passing a context variable between AI plugins and not passing complex data between the AI plugins.

FIG. 6 shows a block diagram of an example computing system.

### DETAILED DESCRIPTION

As discussed above, some recent artificial intelligence (AI) models utilize tokenization and word embeddings to represent words in input sequences, or prompts. An AI system can include prompt generation logic to form a prompt from a user input. As a user input (e.g. a query or command) can request multiple items of information of multiple types, the user input may be processed using multiple AI plugins. An AI plugin can execute one or more tools, such as a database query, a compute task, or an AI model, such as a Large Language Model (LLM). To facilitate responding to such a user input, a computer program referred to as an orchestrator can be implemented to process user inputs into a prompt and select one or more AI plugins to process the prompt. Where multiple AI plugins are selected to process the user input in an AI pipeline, the output from a first AI plugin may be used to construct a next prompt as input to the next AI plugin. Outputs from the next AI plugin likewise can be used to construct a further prompt for inputting into a further AI plugin, or can be provided as a response to the user input if the last AI plugin selected by the orchestrator has completed its task.

However, an LLM may have issues processing and outputting meaningful responses to prompts which contain “non-language text”, referred to here as complex data. One drawback with such models is that the usefulness of the response is greatly influenced by the quality of the prompt. Indeed, prompts that contain complex data, rather than natural language input, may produce erroneous results. Complex data can include 3-dimensional data (e.g., chemical structure data), uniform resource locators (URLs), and/or application-specific code, as examples. Such complex data is typically unsuitable for input to an LLM via tokenization or word embeddings. For example, chemical structure data can include a set of atomic coordinates and an element symbol for each atom. As LLMs are not trained to interpret such non-language text strings, the LLM may output an inappropriate or useless response in response to such a prompt. Additionally, polluting a prompt with unnecessary data tends to degrade the performance of an LLM. As such, long string information resulting from tokenization of complex data can lead to poor results from the LLM.

Further, complex data, when represented as a text string, can comprise relatively long text strings. As an example, chemical structure data for a protein can include XYZ coordinate data for thousands of atoms, where each atom is represented at least by a chemical symbol, an X-coordinate, a Y-coordinate, and a Z-coordinate. As another example, electronic structure data can be orders of magnitude greater than the size of the chemical structure data. When represented as a text string, such complex data can exceed a prompt length limit of an LLM. For example, token limits can range from 512 to 4096 for current state-of-the-art LLMs. In some examples, token limits can be greater (e.g., 32,000). However, use of a relatively large number of tokens can result in slower speeds and/or lower quality responses from an LLM.

Accordingly, examples are disclosed for passing complex data objects as context variables between iterative queries to AI plugins and/or generative models. Briefly, a prompt is constructed based on a received text input. Then, the prompt is provided to an orchestrator. The orchestrator selects one or more AI plugins for processing the prompt. Based on the prompt, the orchestrator forms a context variable to represent complex data. Based on the prompt, the orchestrator provides modified input to a first AI plugin and receives the complex data. The complex data is stored as the context variable. Then, the orchestrator modifies the prompt to include a reference to the context variable. Here, the modified prompt does not include the complex data. The orchestrator provides the modified prompt to a generative model. In this manner, the orchestrator passes the context variable between AI plugins without passing the complex data to the generative model. This can help avoid problems associated with inputting complex data into a generative model, such as useless output from an LLM or exceeding a prompt length limit.

The disclosed examples also can help improve speed and efficiency compared to other examples. For example, by storing complex data objects as context variables and passing the context variable between iterative AI plugins, the AI plugins can omit regenerating data. This can reduce computational time and improve efficiency. Further, AI plugins and generative models can perform processing in parallel, which can also help to reduce computational time. For example, each complex data object output from an AI plugin used to process a user input can be assigned to a corresponding context variable. In parallel, a modified prompt can be provided to a generative model with a reference to the context variable(s). This allows for multiple tasks to be executed in parallel.

By avoiding problems associated with passing complex data to an LLM, the disclosed examples can provide an LLM system that is capable of handling forms of data other than text. This can help improve versatility in generative models. With the ability to pass complex data objects as context variables, a user can utilize an LLM to retrieve complex data objects which can be used in dynamic user experiences, such as data visualization.

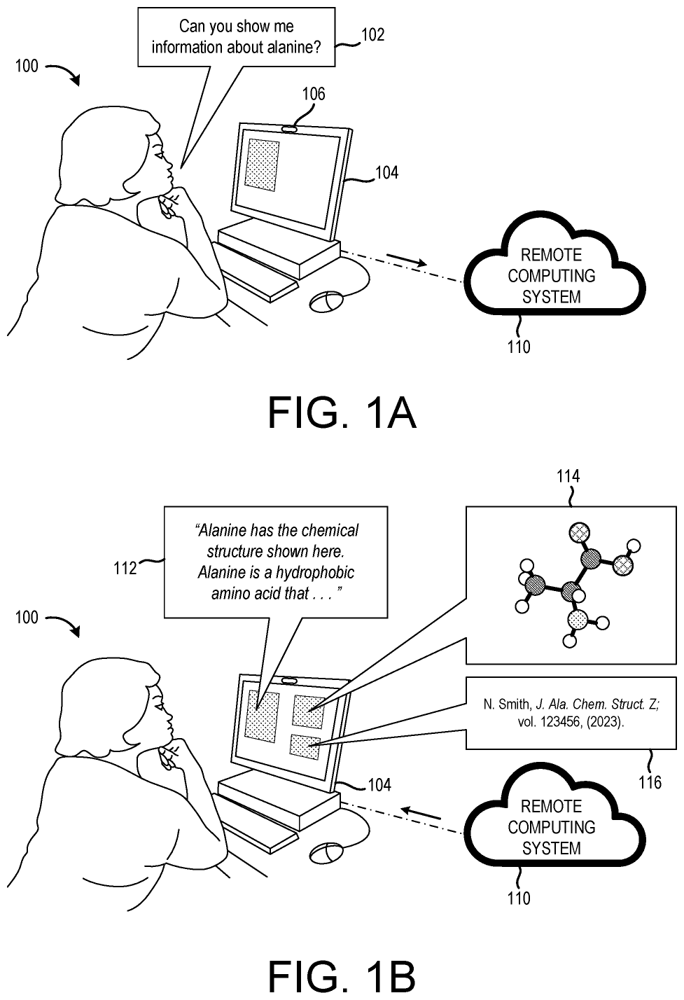

FIGS. 1A-1B show an example usage scenario. As shown, a user 100 provides input 102 to a client computer 104. In this example, the client computer 104 receives input 102 via audio captured by a microphone 106. In other examples, user 100 can use any other suitable input device (e.g., a keyboard) to provide input 102 to the client computer. Client computer 104 may be configured to present a user interface as a result of executing a client program by the processor of the client computer 104. Input 102 can be entered via the user interface in such examples.

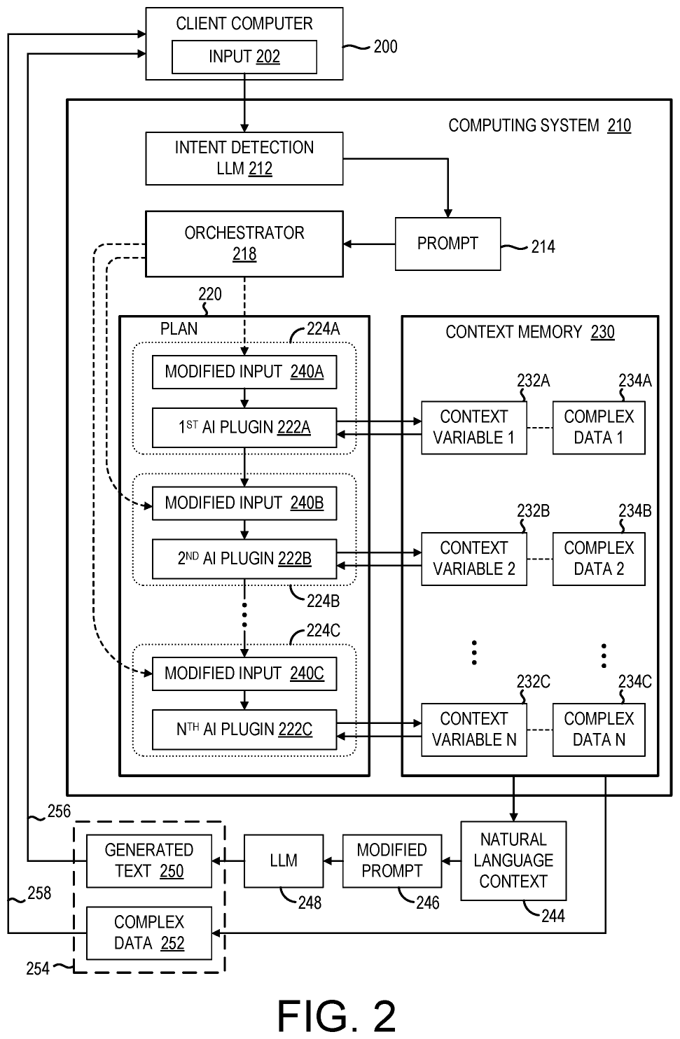

Client computer 104 can communicate with a remote computing system 110. As shown in FIG. 1A, client computer 104 transmits input 102 to remote computing system 110 for processing. Remote computing system 110 comprises instructions to receive input 102 and form a prompt based on input 102. Remote computing system 110 further comprises instructions to execute an orchestrator which can process the prompt using one or more AI plugins and a generative model configured to generate text based at least on a prompt. The orchestrator also manages context memory for storing complex data objects as context variables, the complex data objects being output from the one or more AI plugins. The orchestrator is configured to pass a context variable between AI plugins and/or generative models without passing the complex data object corresponding to the context variable. An example orchestrator is described in more detail below with respect to FIG. 2.

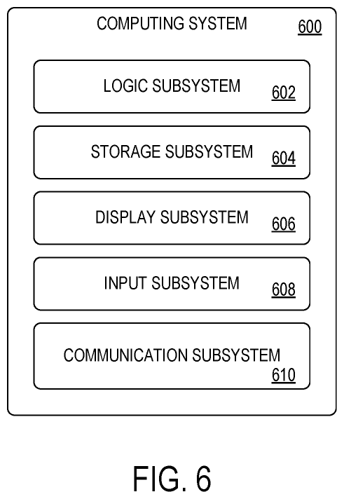

Here, both remote computing system 110 and client computer 104 may include respective processors, memory, and storage devices. Examples of computing systems are described in more detail below with respect to FIG. 6. Client computer 104 can take the form of a personal computer, laptop, tablet, smartphone, etc. Remote computing system 110 can comprise a cloud-accessible networked computing system in some examples.

Continuing to FIG. 1B, client computer 104 is configured to receive output from remote computing system 110. Client computer 104 is further configured to perform an action in response to receiving a complex data object from remote computing system 110. For example, client computer 104 may be configured to store and present a complex data object to user 100, and/or execute one or more software applications based on the complex data object received. Examples of complex data objects include chemical structure data, citation data, URLs, CAD (computer aided drafting) data objects, dictionary data objects, audio data, and video data.

FIG. 1B shows the results of processing input 102 at remote computing system 110 and providing output to client computer 104. In this example, the output comprises generated text 112 and complex data including chemical structure data 114 and citation data 116. Upon receiving the output from remote computing system 110, client computer 104 displays generated text 112 to the user 100. In some examples, generated text 112 additionally or alternatively can be presented as audio output through one or more speakers of client computer 104. Client computer 104 also displays chemical structure data 114 in a chemical visualization application. Additionally, client computer 104 displays citation data 116 in a citation management application. In other examples, client computer alternatively or additionally may be configured to perform other suitable action(s) in response to receiving a complex data object (e.g., retrieve a file from a URL).

With the ability to pass complex data objects as context variables, a user can utilize an AI pipeline comprising an LLM to retrieve complex data. As such, remote computing system 110 can help provide an enhanced experience to user 100. For example, user 100 can provide natural language input (e.g., input 102) and receive chemical structure data 114 to be visualized in an interactive application on client computer 104. Such visualizations can provide a dynamic user experience. Additionally, citation data 116 can be received and stored in a citation management application and/or inserted inline into a word processing application. This can help provide seamless user experiences for tasks such as scientific writing.

As mentioned above, an orchestrator can be configured to pass a context variable in prompts between AI plugins and/or generative models without passing the complex data object corresponding to the context variable. FIG. 2 schematically shows an example for processing a prompt within an orchestrator. As shown, a client computer 200 sends input 202 to computing system 210. Input 202 can comprise a query, a command, or any other suitable input (e.g., input 102). Input 202 may also be generated and received from a software program, rather than directly from a human user. Computing system 210 is remote to client computer 200. Client computer 104 is an example of client computer 200 and remote computing system 110 is an example of computing system 210. Computing system 210 can comprise a cloud-accessible networked computing system in some examples.

Computing system 210 comprises an intent detection LLM 212 that is configured to construct a prompt 214 from input 202. Computing system 210 further comprises an orchestrator 218. Orchestrator 218 is configured to select one or more AI plugins for processing prompt 214. Orchestrator 218 is further configured to provide inputs into one or more AI plugins, receive output from the one or more AI plugins, and output results, in addition to other functions. For example, based on prompt 214, orchestrator 218 creates a plan 220. As shown in FIG. 2, plan 220 comprises one or more AI plugins selected by orchestrator 218 for processing prompt 214 including first AI plugin 222A, second AI plugin 222B, and N^{th} AI plugin 222C. Here, prompt processing refers to fulfilling a goal, direct or indirect, that is defined by prompt 214. This processing occurs at one or more corresponding orchestration stages 224A, 224B, 224C.

AI plugins can comprise any suitable tool(s), such as a database query, a compute task, or an AI model. Examples of database query tools include a chemical database application, a literature search model, and/or a NOSQL database query. An example of a compute task is molecular simulation, such as that performed by quantum mechanics calculation applications. Examples of AI models include generative models, such as an LLM. As an example, first AI plugin 222A can comprise a chemical database application, second AI plugin 222B can comprise a literature search model, and N^{th} AI plugin 222C can comprise an LLM.

Computing system 210 further comprises context memory 230 which is shared and accessible to each of orchestration stages 224A, 224B, 224C. Context memory 230 may comprise any suitable data related to prompt processing, such as input data, output data, user session history, and prompt history. Such data can be passed between orchestration stages and/or stored. As described in more detail below, context memory 230 also holds context variables 232A, 232B, 232C and corresponding complex data 234A, 234B, 234C.

As discussed above, complex data may be unsuitable for input to an LLM. For example, a string-based representation of a complex data object may comprise a string size that is greater than an upper limit (e.g., 512, 4096, etc.) for a prompt input string. This can overwhelm a generative model and produce erroneous output. Additionally, tokenization and embedding of a complex data object will lead to erroneous outputs from an LLM. As such, based on prompt 214, orchestrator 218 can form a context variable (e.g., context variable 232A) to represent complex data (e.g., complex data 234A). Then, orchestrator 218 provides modified input 240A to first AI plugin 222A and receives output from the first AI plugin 222A, the output including complex data 234A. Complex data 234A is assigned to context variable 232A and stored in context memory 230. Orchestrator 218 can receive one or more additional complex data objects at one or more subsequent orchestration stages. In some examples, an AI plugin can output two or more complex data objects. As shown in FIG. 2, context memory 230 can store any suitable number N of complex data objects assigned to corresponding context variables.

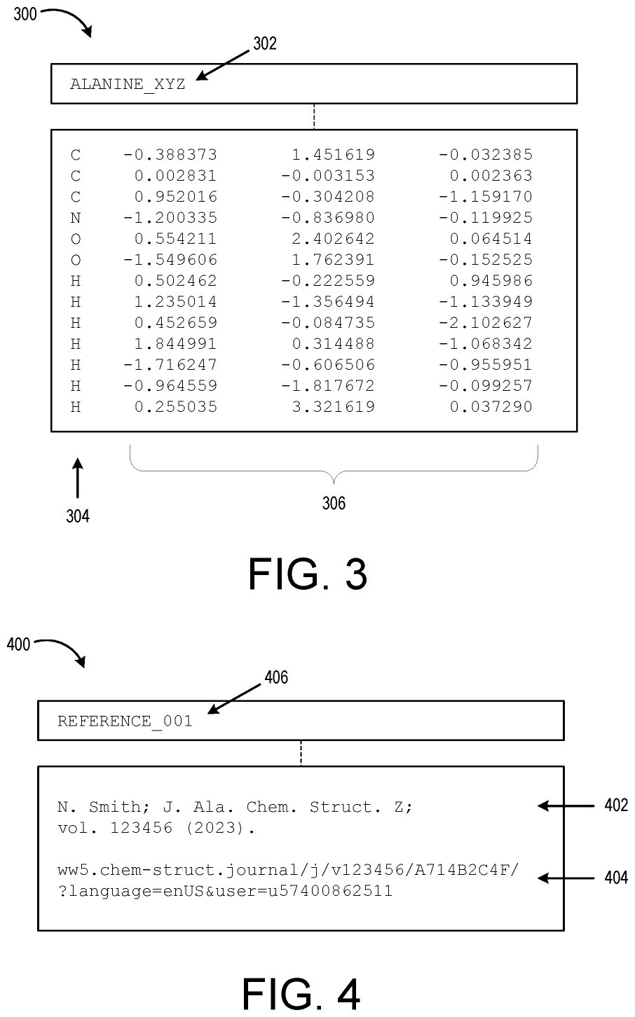

Complex data objects may comprise any suitable type or types of data objects. Examples include chemical structure data, citation data, and/or URL data. FIG. 3 shows an example complex data object comprising chemical structure data 300. In this example, chemical structure data 300 comprises data for an alanine molecule. Chemical structure data 300 is stored as a context variable 302 comprising a molecule name. Chemical structure data 300 further comprises atomic species data 304 and XYZ coordinate data 306 for each atom in the chemical structure.

Chemical structure data can comprise data for any suitable chemical structure, such as a molecule, a crystalline solid, a surface, or combination thereof. In some examples, chemical structure data comprises data for a quantum chemistry calculation, or a molecular dynamics simulation. In some examples, chemical structure data can further include information related to molecular mass, electronic structure, magnetic properties, atomic charge, molecular orbitals, intramolecular bonding, intermolecular bonding, symmetry groups, lattice constants, bulk modulus, band gaps, and/or other chemical data.

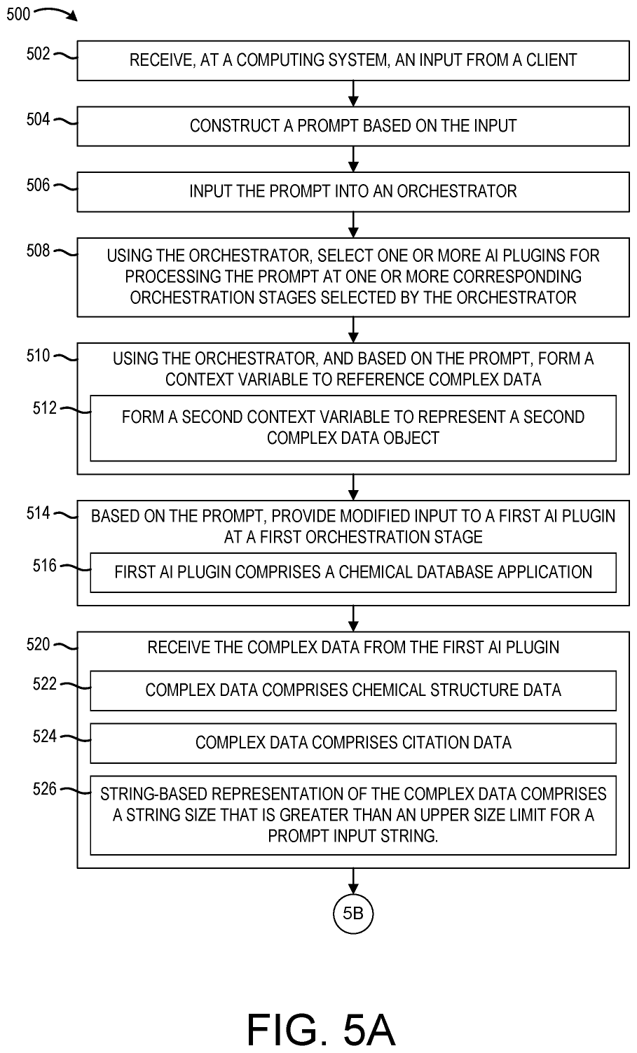

FIG. 4 shows an example of citation data 400 comprising a URL. Citation data 400 is an example of complex data 234A, 234B, 234C. In this example, citation data 400 comprises a journal citation 402 and a URL 404. Citation data 400 is stored as a context variable 406 comprising a citation identifier. In some examples, citation data can comprise a plurality of citations. For example, a literature search model may output 1000's of citations or more related to an input.

In other examples, complex data 234A, 234B, 234C can comprise a different type of data object. Further examples of complex data objects include CAD (computer aided drafting) data objects, dictionary data objects, audio data, and video data.

Returning to FIG. 2, orchestrator 218 also provides a modified input 240B to second AI plugin 222B at second orchestration state 224B. In some examples, modified input is formed based on output from a prior orchestration stage. For example, based on the output of first AI plugin 222A, orchestrator 218 can form modified input 240B that includes a reference to context variable 232A. Second AI plugin 222B outputs complex data 234B which is stored as context variable 232B. Further, orchestrator 218 also provides a modified input 240C to N^{th} AI plugin 222C at N^{th} orchestration state 224C. Modified input 240C may be based on output from orchestration stage 224A and/or orchestration stage 224B. N^{th} AI plugin 222C outputs complex data 234C which is stored as context variable 232C. Plan 220 can comprise any suitable number of AI plugins for processing prompt 214. Further, orchestrator 218 can form a plurality of context variables for storing a respectively plurality of complex data objects. In some examples, one or both of orchestration stage 224B or orchestration stage 224C can be omitted.

Further, by passing a context variable, iterative AI plugins can avoid regenerating complex data. As an example, when provided with modified input 240A that includes a reference to context variable 232A, second AI plugin 222B (or N^{th} AI plugin 222C) can omit generating complex data 234A. This can help save computational time and resources.

After processing the one or more orchestration stages 224A, 224B, 224C, context memory is fed to natural language context processing at 244. Natural language context processing forms a modified prompt 246. Natural language context processing may utilize any suitable data stored in context memory 230, such as prompt 214, to form modified prompt 246. Then, modified prompt 246 is provided to an LLM 248. Modified prompt 246 includes a reference to one or more context variables 232A, 232B, or 232C. As an example, context variable 302, “ALANINE_XYZ” may be represented as “structural data for alanine” in natural language context. However, modified prompt 246 may or may not include complex data 234A, 234B, or 234C. As such, complex data may or may not be passed in modified prompt 246 to LLM 248. This can help to avoid issues described above related to passing complex data to an AI model, such as input that exceeds the token limit of an LLM. This can also help avoid erroneous output from a generative model.

As mentioned above, AI plugins and generative models can execute tasks in parallel in some examples. For example, orchestrator 218 can provide modified input 240A to first AI plugin 222A. Orchestrator 218 also can provide modified prompt 246 to LLM 248. In examples where LLM 248 does not depend on complex data output from first AI plugin 222A, LLM 248 can process modified prompt 246 in parallel with first AI plugin 222A processing modified input 240A. In some examples, one or more of first AI plugin 222A, second AI plugin 222B, and N^{th} AI plugin 222C can execute tasks in parallel. In this manner, the disclosed examples can allow for simultaneous processing of prompts across iterative AI models. This can help reduce overall computational time. In other examples, the results of an AI plugin can be passed to another AI plugin, or used to inform generated text from LLM 248. In such examples, processing tasks may be performed in series rather than in parallel.

Based on modified prompt 246, LLM 248 outputs generated text 250. Generated text 250 can comprise a reference to a context variable to which complex data 252 is assigned. For example, generated text 250 can comprise a pointer to complex data 252. As more specific examples, generated text 250 can comprise a reference to one or more of context variable 232A, context variable 232B, or context variable 232C. In further examples, generated text 250 comprises an answer to a user. An answer can comprise a sufficiently short portion of data within complex data 252. For example, input 202 may include a query asking if a “material X” contains a “property Y”. In such examples, complex data 252 may include a Boolean answer to the query, which can be referenced in generated text 250. As another example, generated text 250 may include a numerical value for a bandgap of a material while complex data 252 comprises complex data from a quantum mechanics calculation performed by an AI plugin to determine the bandgap. Complex data 252 comprises one or more of complex data 234A, complex data 234B, or complex data 234C corresponding to the context variable referenced by generated text 250. As shown by arrows 256, 258, output 254 is then provided to client computer 200. While data from context memory 230 is provided to client computer 200, context variables and complex data are treated differently. Here, one or more context variables form the natural language context 244 that is used by LLM 248 to output generated text 250. In contrast, complex data 252 is passed directly to client computer 200.

Upon receiving output 254, client computer 200 displays generated text 250 to a user. Further, the complex data can be used in any desired manner. The complex data is too large and/or too complicated to be passed through an LLM user interface on client computer 200. As such, complex data 252 can be stored on client computer 200 and/or passed to a software application. For example, a software application on client computer 200 can perform an action based on the complex data 252. Any suitable action can be performed. For example, upon receiving chemical structure data, client computer 200 can pass the chemical structure data to a chemical visualization application. Such an example is illustrated in FIG. 1B at 114. In some examples, complex data 252 comprises citation data and client computer 200 imports the citation data into a software application, such as citation management application. In some examples, complex data 252 comprises a URL and client computer 200 performs an action based on the URL, for example, by opening a web browser to navigate to the URL or by retrieving a file from the URL. In some examples, complex data 252 comprises CAD object data and client computer 200 opens a model viewer in a CAD software application. In other examples, client computer 200 can perform any other suitable action(s) in response to receiving a complex data object.

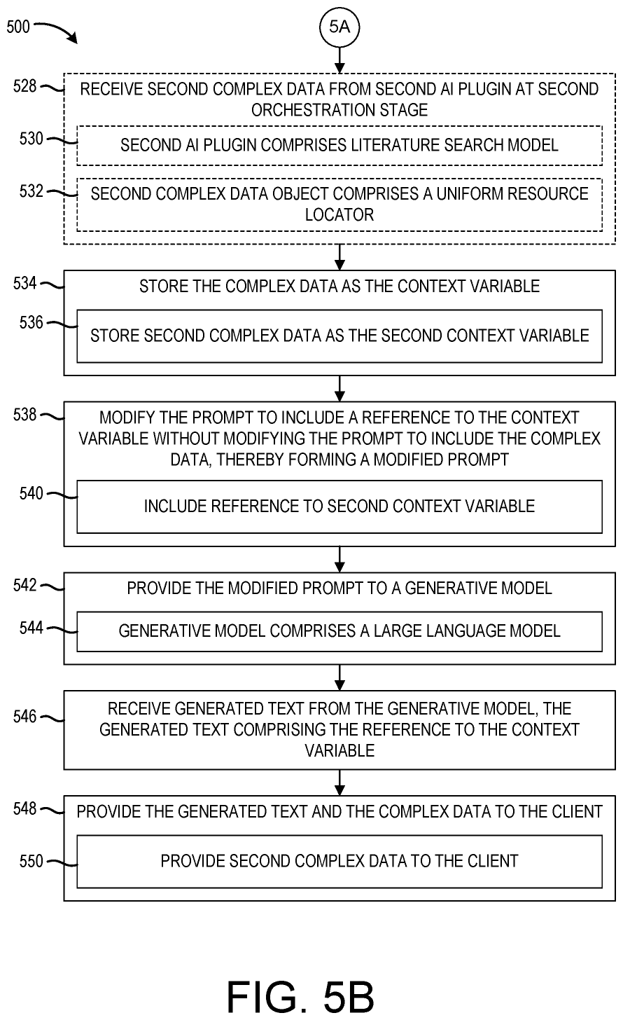

FIGS. 5A-5B show a flow diagram for an example method 500 for processing a prompt using a context variable to reference complex data. Method 500 can be enacted on a computing system, e.g., remote computing system 110 and/or computing system 210. Method 500 comprises, at 502, receiving, at the computing system, an input from a client.

Method 500 further comprises, at 504, constructing a prompt based upon the input. In some examples, an LLM (e.g., intent detection LLM 212) can be used to construct the prompt at 504. Method 500 further comprises, at 506, inputting the prompt into an orchestrator (e.g., orchestrator 218). The orchestrator is configured to create a plan comprising one or more orchestration stages. The orchestrator is further configured to, at each orchestration stage, provide input and receive output from an AI plugin. Method 500 further comprises, at 508, using the orchestrator, selecting one or more AI plugins for processing the prompt at one or more corresponding orchestration stages.

Method 500 further comprises, at 510, using the planner, and based on the prompt, forming a context variable to represent complex data. In some examples, at 512, method 500 comprises forming a second context variable to represent second complex data.

Continuing, at 514, method 500 comprises, based on the prompt, providing modified input to a first AI plugin at a first orchestration stage. In some examples, at 516, the first AI plugin comprises a chemical database application.

Method 500 further comprises, at 520, receiving the complex data from the first AI plugin. In some examples, at 522, the complex data comprises chemical structure data. In some examples, at 524, the complex data comprises citation data. In some examples, at 526, a string-based representation of the complex data comprises a string size that is greater than an upper size limit for a prompt input string. For example, a prompt input for some generative models (e.g., an LLM) can have a size limit. In some such examples, the limit can be in a range of 512 to 4096 tokens. As such, a complex data object comprising a string size that is greater than the limit of the model can lead to useless output from the model. To avoid such issues, the complex data object is not included in a modified prompt (e.g., step 528 below).

Continuing to FIG. 5B, in some examples, at 528, method 500 optionally comprises receiving a second complex data from a second AI plugin at a second orchestration stage. In some such examples, at 530, the second AI plugin comprises a literature search model. In some such examples, at 532, the second complex data comprises a URL.

Continuing, at 534, method 500 comprises storing the complex data as the context variable. In some examples, when step 528 is performed, method 500 can optionally comprise storing the second complex data as the second context variable.

Method 500 further comprises, at 538, modifying the prompt to include a reference to the context variable without modifying the prompt to include the complex data, thereby forming a modified prompt. By not including the complex data, the method helps avoid the problems discussed above related to passing complex data to an LLM. In some examples, at 540, method 500 optionally comprises including a reference to a second context variable. Step 540 can be performed when step 528 is performed, for example.

Method 500 further comprises, at 542, providing the modified prompt to a generative model. In some examples, at 544, the generative model comprises an LLM. At 546, method 500 comprises receiving generated text from the generative model, the generated text comprising a reference to the context variable. In some examples, when steps 528 and steps 540 are performed, the generated text can further comprise a reference to the second context variable.

Continuing, at 548, method 500 comprises providing the generated text and the complex data to the client. In some examples, at 550, method 500 also comprises providing the second complex data to the client with the first complex data object.

Thus, by storing complex data objects as context variables and passing the context variables between iterative AI plugins and AI models, the disclosed examples can help avoid problems such as erroneous output from generative models, or exceeding a prompt length limit. By avoiding regenerating data, the disclosed examples also can help improve speed and efficiency compared to other examples. Further, AI plugins can process prompts in parallel, which can also help to reduce overall computational time. The disclosed examples also can provide for generative models that are capable of handling forms of data other than text. This can help improve versatility in generative models and enhance user experiences.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic subsystem 602 and a storage subsystem 604. Computing system 600 may optionally include a display subsystem 606, input subsystem 608, communication subsystem 610, and/or other components not shown in FIG. 6.

Logic subsystem 602 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic subsystems configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 604 includes one or more physical devices configured to hold instructions executable by the logic subsystem to implement the methods and processes described herein. When such methods and processes are implemented, the state of storage subsystem 604 may be transformed—e.g., to hold different data.

Storage subsystem 604 may include removable and/or built-in devices. Storage subsystem 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices.

It will be appreciated that storage subsystem 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 602 and storage subsystem 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic subsystem 602 executing instructions held by storage subsystem 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage subsystem 604. This visual representation may take the form of a graphical user interface (GUI). As the herein described methods and processes change the data held by the storage subsystem, and thus transform the state of the storage subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or storage subsystem 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

Another example provides a method enacted on a computing system. The method comprises receiving, at the computing system, an input from a client, constructing a prompt based upon the input, inputting the prompt into an orchestrator, and, using the orchestrator, selecting one or more artificial intelligence (AI) plugins for processing the prompt at one or more corresponding orchestration stages selected by the orchestrator. The method further comprises, using the orchestrator, and based on the prompt, forming a context variable to reference complex data, providing modified input to a first AI plugin at a first orchestration stage, receiving the complex data from the first AI plugin, and storing the complex data as the context variable. The method further comprises modifying the prompt to include a reference to the context variable without modifying the prompt to include the complex data, thereby forming a modified prompt, providing the modified prompt to a generative model, receiving generated text from the generative model, the generated text comprising the reference to the context variable, and providing the generated text and the complex data to the client. In some such examples, the first AI plugin comprises a chemical database application. In some such examples, the generative model additionally or alternatively comprises a large language model. In some such examples, the context variable is a first context variable, the complex data is first complex data, and the method additionally or alternatively comprises, using the orchestrator, forming a second context variable to reference second complex data, receiving the second complex data from a second AI plugin at a second orchestration stage, storing the second complex data as the second context variable, including a reference to the second context variable in the modified prompt, and providing the second complex data to the client with the first complex data. In some such examples, the second AI plugin comprises a literature search model. In some such examples, the second context variable additionally or alternatively comprises a uniform resource locator (URL). In some such examples, the first AI plugin additionally or alternatively comprises a chemical database application, and the first complex data additionally or alternatively comprises chemical structure data. In some such examples, the complex data additionally or alternatively comprises chemical structure data. In some such examples, the complex data additionally or alternatively comprises citation data.

Another example provides a computing system comprising a logic subsystem and a storage subsystem comprising instructions executable by the logic subsystem to receive, at the computing system, an input from a client, construct a prompt based upon the input, and input the prompt into an orchestrator. The instructions are further executable to, using the orchestrator, select one or more artificial intelligence (AI) plugins for processing the prompt at one or more corresponding orchestration stages, using the orchestrator, and based on the prompt, form a context variable to reference complex data, provide modified input to a first AI plugin at a first orchestration stage, receive the complex data from the first AI plugin, and store the complex data as the context variable. The instructions are further executable to modify the prompt to include a reference to the context variable without modifying the prompt to include the complex data, thereby forming a modified prompt, provide the modified prompt to a generative model, receive generated text from the generative model, the generated text comprising the reference to the context variable, and provide the generated text and the complex data to the client. In some such examples, the context variable is a first context variable, wherein the complex data is first complex data, and the instructions are further executable to, using the orchestrator, form a second context variable to represent second complex data, receive the second complex object from a second AI plugin at a second orchestration stage, store the second complex data as the second context variable, modify the prompt to include a reference to the second context variable in the modified prompt without modifying the prompt to include the second complex data, and provide the second complex data to the client with the first complex data. In some such examples, the second AI plugin additionally or alternatively comprises a literature search model. In some such examples, the second context variable additionally or alternatively comprises a uniform resource locator (URL). In some such examples, the first AI plugin additionally or alternatively comprises a chemical database application, and the first complex data comprises chemical structure data. In some such examples, the complex data additionally or alternatively comprises chemical structure data. In some such examples, the complex data additionally or alternatively comprises citation data.

Another example provides a computing system comprising a logic subsystem and a storage subsystem comprising instructions executable by the logic subsystem to receive, at the computing system, an input from a user, the input comprising a request for information on a chemical, and send the input to a remote computing system comprising an artificial intelligence (AI) orchestrator, the AI orchestrator configured to generate a context variable to store chemical structure data received from an AI plugin selected by the orchestrator for responding to the input. The instructions are further executable to receive generated text from the remote computing system, receive the chemical structure data from the computing system, output the generated text to the user, and display a visualization of a structure of the chemical to the user. In some such examples, the generated text further comprises a reference to citation data, and the instructions are further executable to receive a uniform resource locator (URL) from the computing system. In some such examples, the instructions additionally or alternatively are further executable to perform an action based on the URL. In some such examples, the instructions additionally or alternatively are further executable to store the citation data with the URL.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. Enacted on a computing system, a method, comprising:
receiving, at the computing system, an input from a client;
constructing a prompt based upon the input;
inputting the prompt into an orchestrator;
using the orchestrator, selecting one or more artificial intelligence (AI) plugins for processing the prompt at one or more corresponding orchestration stages selected by the orchestrator;
using the orchestrator, and based on the prompt, forming a context variable to reference complex data;
providing modified input to a first AI plugin at a first orchestration stage;
receiving the complex data from the first AI plugin;
storing the complex data as the context variable;
modifying the prompt to include a reference to the context variable without modifying the prompt to include the complex data, thereby forming a modified prompt;
providing the modified prompt to a generative model;
receiving generated text from the generative model, the generated text comprising the reference to the context variable; and
providing the generated text and the complex data to the client.

2. The method of claim 1, wherein the first AI plugin comprises a chemical database application.

3. The method of claim 1, wherein the generative model comprises a large language model.

4. The method of claim 1, wherein the context variable is a first context variable, wherein the complex data is first complex data, and further comprising:
using the orchestrator, forming a second context variable to reference second complex data,
receiving the second complex data from a second AI plugin at a second orchestration stage,
storing the second complex data as the second context variable,
including a reference to the second context variable in the modified prompt, and
providing the second complex data to the client with the first complex data.

5. The method of claim 4, wherein the second AI plugin comprises a literature search model.

6. The method of claim 5, wherein the second context variable comprises a uniform resource locator (URL).

7. The method of claim 4, wherein the first AI plugin comprises a chemical database application, and the first complex data comprises chemical structure data.

8. The method of claim 1, wherein the complex data comprises chemical structure data.

9. The method of claim 1, wherein the complex data comprises citation data.

10. A computing system comprising:
a logic subsystem; and
a storage subsystem comprising instructions executable by the logic subsystem to
receive, at the computing system, an input from a client;
construct a prompt based upon the input;
input the prompt into an orchestrator,
using the orchestrator, select one or more artificial intelligence (AI) plugins for processing the prompt at one or more corresponding orchestration stages;
using the orchestrator, and based on the prompt, form a context variable to reference complex data;
provide modified input to a first AI plugin at a first orchestration stage;
receive the complex data from the first AI plugin;
store the complex data as the context variable;
modify the prompt to include a reference to the context variable without modifying the prompt to include the complex data, thereby forming a modified prompt;
provide the modified prompt to a generative model;
receive generated text from the generative model, the generated text comprising the reference to the context variable; and
provide the generated text and the complex data to the client.

11. The computing system of claim 10, wherein the context variable is a first context variable, wherein the complex data is first complex data, and the instructions are further executable to:
using the orchestrator, form a second context variable to represent second complex data,
receive the second complex object from a second AI plugin at a second orchestration stage,
store the second complex data as the second context variable,
modify the prompt to include a reference to the second context variable in the modified prompt without modifying the prompt to include the second complex data, and
provide the second complex data to the client with the first complex data.

12. The computing system of claim 11, wherein the second AI plugin comprises a literature search model.

13. The computing system of claim 12, wherein the second context variable comprises a uniform resource locator (URL).

14. The computing system of claim 12, wherein the first AI plugin comprises a chemical database application, and the first complex data comprises chemical structure data.

15. The computing system of claim 10, wherein the complex data comprises chemical structure data.

16. The computing system of claim 10, wherein the complex data comprises citation data.

17. A computing system comprising:
a logic subsystem; and
a storage subsystem comprising instructions executable by the logic subsystem to
receive, at the computing system, an input from a user, the input comprising a request for information on a chemical,
send the input to a remote computing system comprising an artificial intelligence (AI) orchestrator, the AI orchestrator configured to generate a context variable to store chemical structure data received from an AI plugin selected by the orchestrator for responding to the input,
receive generated text from the remote computing system,
receive the chemical structure data from the computing system,
output the generated text to the user, and
display a visualization of a structure of the chemical to the user.

18. The computing system of claim 17, wherein the generated text further comprises a reference to citation data, and the instructions are further executable to receive a uniform resource locator (URL) from the computing system.

19. The computing system of claim 18, wherein the instructions are further executable to perform an action based on the URL.

20. The computing system of claim 18, wherein the instructions are further executable to store the citation data with the URL.
